(19) United States
(12) Patent Application Publication
(10) Pub. No.: US 2007/0264996 A1
(43) Pub. Date: Nov. 15, 2007

(54) MOBILE COMMUNICATION WITH UNLICENSED-RADIO ACCESS NETWORKS

(76) Inventor: Jari Vikberg, Jama (SE)

Correspondence Address: NIXON & VANDERHYE, PC, 901 NORTH GLEBE ROAD, 11TH FLOOR, ARLINGTON, VA, 22203, US

(21) Appl. No.: 11/547,013

(22) PCT Filed: Mar. 30, 2004
(86) PCT No.: PCT/EP04/03367

§ 371 Date: Jun. 4, 2007

(51) Int. Cl. H04Q 7/20

(52) U.S. Cl. 455/426.1

(57) ABSTRACT

A mobile telecommunications network includes a core network portion, a first access network and a second access network. The first access network comprises a plurality of base stations adapted to communicate with mobile stations via a licensed radio interface and with the core network portion. The second access network comprises a plurality of access points each defining a mini-cell and adapted to communicate with mobile stations over an unlicensed-radio interface and an access network controller adapted to communicate with the core network portion and with the plurality of access points. The second access network is further adapted to set up a radio link with a mobile station that is entering a mini-cell and conducting an active call with the first access network and to communicate a cell identifier to the mobile station. The cell identifier identifies at least one mini-cell of the second access network to the core network portion for handover. At least one base station of the first access network is adapted to receive a handover proposal message from the mobile station containing the cell identifier and to communicate the cell identifier to the core network portion in a message indicating that handover is required.

### FIELD OF INVENTION

The invention concerns mobile communication combining both public mobile access networks and unlicensed access networks. The invention has specific relevance to the transfer of connections between public mobile networks and unlicensed-radio access networks.

### BACKGROUND ART

In any mobile communication system, such as a GSM network, active calls conducted between a mobile station and a base station need to be handed over to a different base station as the mobile station moves between different coverage areas, or cells. Depending on how each cell is defined, handover may require the active call to be re-routed simply through a different base station transceiver BTS, through a different base station controller BSC or through a different mobile services switching center MSC. Handover may also be necessary when capacity problems are met in any one cell.

Handover involves a certain amount of operation and maintenance activities, in the network such as defining neighbouring cells, as well as the base station controller BSC and mobile services switching center MSC that controls the cell, defining which cell frequencies should be measured and what threshold value to use to initiate handover. In a conventional GSM network the base station controller BSC sends a mobile station a list of frequencies to be measured. Two lists may be sent out, a first list being used for idle mode, such as when the mobile station is roaming, and a second used for active mode when a call is ongoing. This second list defines which frequencies the mobile station should measure and report back on. These lists contain a set of values that refer to absolute radio frequency channel numbers ARFCN of neighbouring cells. In addition to these frequency channel numbers the base station controller BSC also knows base station identity codes BSIC of all neighbouring cells. The mobile station measures the frequencies defined by these channel numbers and reports these measurements to the base station controller. In practice, the mobile station will report on only the six best measurement values and only for those cell frequencies with which that the mobile station can synchronise and consequently receive an identity code relating to the base station (BSIC). The measurement report sent back to the base station controller BSC by the mobile station MS includes a reference to the absolute radio frequency channel numbers ARFCN, the base station identity codes (BSIC) and an indication of the received downlink signal strength. In fact the report does not specify the exact absolute radio frequency channel numbers ARFCN but rather refers to the position this number occupied in the measurement list. On the basis of this report, the base station controller BSC decides whether handover is necessary and to which cell. The initiation of handover is performed according to the standard GSM mechanism for each vendor. Specifically, a message is sent by the base station controller to the mobile services switching center MSC connected to the base station controller BSC indicating that handover is required. This message contains a cell identifier list containing one or more cell global identifiers CGI, which define the mobile country code, mobile network code, location area code and cell identity for the cell to which handover is requested. The cell global identifier CGI is fetched by the base station controller from a list using the base station identification code BSIC and absolute radio frequency channel number ARFCN obtained for the cell. With this cell global identification CGI the mobile services switching center MSC is able to determine which other MSC handles the cell defined by the CGI value.

Conventional cellular networks may be extended by including access networks that utilise a low power unlicensed-radio interface to communicate with mobile stations. These access networks are designed to be used together with the core elements of a standard public mobile network. The access network is constructed so that the core elements, such as the mobile switching centers MSC, of the public mobile network views the unlicensed-radio access network as a conventional base station controller BSC. Such an access network and the mobile station for use with this access network are described in European patent application No. EP-A-1 207 708. The access network consists of an access controller that connects to the core network and a plurality of low power access points. The access points are connected to the access controller via a broadband packet-switched network. The low power and resultant low range of the unlicensed-radio interface means that several such access networks may be provided in relatively close proximity, for example one access network per floor of an office building. The use of an already existing broadband network to connect the access points and the access controller greatly facilitates the installation of the access network, permitting a subscriber to install the access network in his own home himself, for example. Suitable unlicensed-radio formats include digital enhanced cordless telecommunications (DECT), wireless LAN and Bluetooth. An adapted mobile handset capable of operating over both the standard air interface (e.g. the Um interface) and the unlicensed-radio interface means that the subscriber requires only one phone for all environments.

The problem when including one or more unlicensed-radio access networks in a conventional public licensed mobile network such as a GSM, UMTS or CDMA2000 network is that handover from the public licensed mobile network to the unlicensed-radio access network greatly increases the necessary operational and maintenance activities required, in some cases to unacceptably high levels. Depending on the number of unlicensed-radio access networks present, the number of access points could amount to thousands or tens of thousands. Defining these access points in the relevant elements of the public licensed mobile network would be a time-consuming and costly task. In addition, several unlicensed-radio access points may be located in the same public licensed mobile network cell. The number of frequencies requiring measurement within the cell in addition to those of the cells adjacent the public licensed mobile network may be too large to include in the conventional measurement report. In addition the ease of installation of the individual access points of an unlicensed-radio access network means that the number and location of these access points could be constantly changing. Each change would require the configuration of public licensed mobile network to be updated to take account of the new location of the access points.

### SUMMARY OF THE INVENTION

It is thus an object of the present invention to propose a system of handling handover from a conventional public licensed mobile network, such as GSM, UTMS or CDMA2000 to an unlicensed-radio access network connected to the conventional network.

This object is achieved in a mobile telecommunications network, a mobile station and a method of performing handover of an active call between a licensed radio access network and an unlicensed-radio access network in accordance with the appended claims.

Specifically a mobile telecommunications network in accordance with the present invention includes a core network portion, at least a first access network and at least a second access network portion. The first access network portion comprises a plurality of base stations adapted to communicate with mobile stations via a licensed radio interface and with the core network portion. The second access network comprises a plurality of access points each defining a mini-cell and adapted to communicate with mobile stations located in a respective mini-cell over an unlicensed-radio interface and an access network controller adapted to communicate with the core network portion over a predetermined licensed mobile network interface and connected with the plurality of access points. The second access network is further adapted to set up a radio link with a mobile station that is entering a mini-cell and conducting an active call with the first access network and to communicate a cell identifier to the mobile station. The cell identifier identifies at least one mini-cell of the second access network to the core network portion to enable handover of an active call from the first access network to the second access network. At least one base station of the first access network is adapted to receive a message from the mobile station containing the cell identifier and to communicate the cell identifier to the core network portion in a message indicating that handover is required.

By communicating a cell identifier indicating a mini-cell of the unlicensed-radio access network to which handover can be performed to the base station of the conventional cellular network using the mobile station there is no need for the identification of the access point to be configured in the base stations on installation of the unlicensed radio access network. The cell identifier need only be configured in the core network portion, which greatly simplifies the operation and maintenance functions on installation of a new unlicensed-radio access network. Moreover, the displacement, addition or removal of access points within an unlicensed-radio access network can be performed without the need for further modifying the public licensed cellular network.

Preferably, the cell identifier is the same for all mini-cells of an unlicensed radio access network. This still further reduces the required configuration overheads by limiting the number of identifiers that have to be configured in the core network portion.

### BRIEF DESCRIPTION OF THE DRAWINGS

Further objects and advantages of the present invention will become apparent from the following description of the preferred embodiments that are given by way of example with reference to the accompanying drawings. In the figures:

FIG. 1 schematically depicts parts of a GSM network with an unlicensed-radio access network,

FIG. 2 schematically depicts the unlicensed-radio access network of FIG. 1,

FIG. 3 illustrates the signalling sequence for handover of a call from a public mobile network, such as GSM to an unlicensed-radio access network,

### DETAILED DESCRIPTION OF THE DRAWINGS

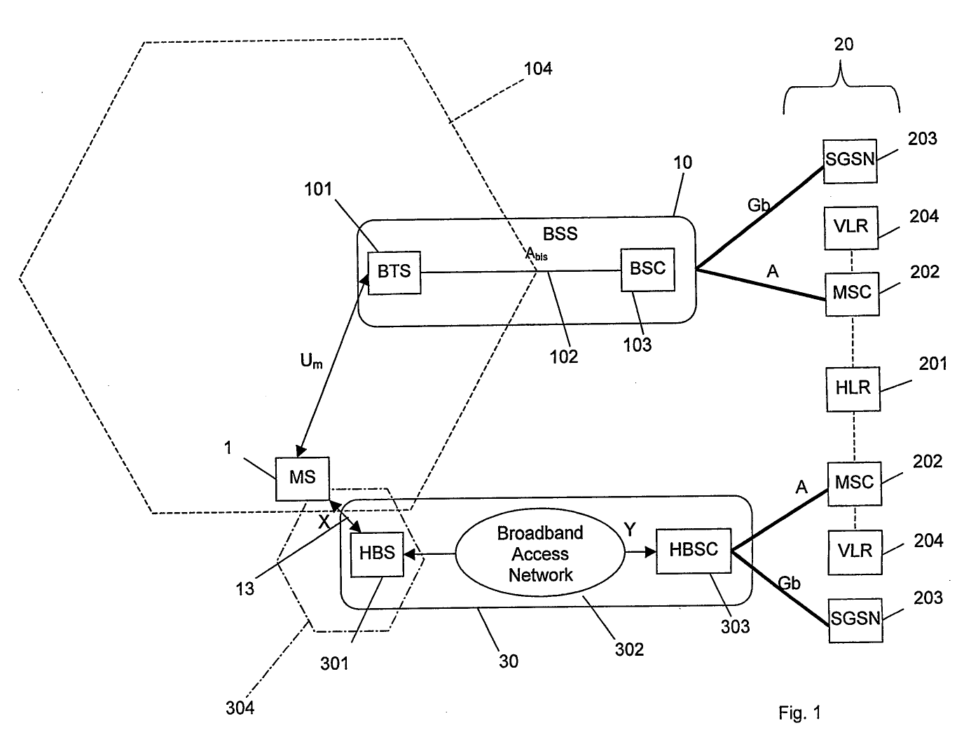

FIG. 1 schematically depicts parts of a conventional GSM network. This network is essentially divided into a core network portion 20 and an access portion 10. The elements of the core network illustrated in the figure include the mobile switching centers or MSCs 202, associated home location register HLR 201 and visitor location register VLR 204. The function and structure of these conventional GSM architecture elements are known to those in the art and will not be described in further detail here. The core network also supports the General Packet Radio Service (GPRS), and to this end serving GPRS support nodes (SGSN) 203 are also illustrated. Although not shown in the figure, it will be understood by those skilled in the art that the core network portion may include access to other mobile and fixed-line networks, such as ISDN and PSTN networks, packet and circuit switched packet data networks such as intranets, extranets and the Internet through one or more gateway nodes.

The access portion essentially consists of base station subsystems BSS 10, one of which is illustrated in FIG. 1, which communicate via defined fixed standard A and Gb interfaces with MSCs 202 and SGSNs 203, respectively in the core network portion 20. Each base station subsystem BSS 10 includes a base station controller BSC 103 which communicates with one or more base transceiver stations BTS 101 via the defined A_{bis} air interface 102. The base transceiver stations 101 communicate with mobile stations MS 1 over the GSM standard Uₘ radio air interface. It will be understood that while the BTS 101 and BSC 103 are depicted as forming a single entity in the BSS 10, the BSC 103 is often separate from the BTSs 101 and may even be located at the mobile services switching centre MSC 202.

In addition to the standard access network portion provided by the BSS's 10 the network depicted in FIG. 1 further includes a modified access network portion 30 shown in the lower half of the figure. Hereinafter this will be described as an unlicensed-radio access network portion.

The components making up this unlicensed-radio access network portion 30 also enable the mobile station 1 to access the GSM core network portion, and through this, other communication networks via an unlicensed-radio interface X, represented in FIG. 1 by the bi-directional arrow 31. By unlicensed-radio is meant any radio protocol that does not require the operator running the mobile network to have obtained a license from the appropriate regulatory body. In general, such unlicensed-radio technologies must be low power and thus of limited range compared to licensed mobile radio services. This means that the battery lifetime of mobile stations will be greater. Moreover, because the range is low, the unlicensed-radio may be a broadband radio, thus providing improved voice quality. The radio interface may utilise any suitable unlicensed-radio protocol, for example a wireless LAN protocol or Digital Enhanced Cordless Telecommunications (DECT). Preferably, however, Bluetooth radio is utilised, which has a high bandwidth and lower power consumption than conventional public mobile network radio.

The Bluetooth standard specifies a two-way digital radio link for short-range connections between different devices. Devices are equipped with a transceiver that transmits and receives in a frequency band around 2.45 GHz. This band is available globally with some variation of bandwidth depending on the country. In addition to data, up to three voice channels are available. Each device has a unique 48-bit address from the IEEE 802 standard. Built-in encryption and verification is also available.

The access points to the access network portion 30 adapted to communicate across the Bluetooth interface are called local or home base stations (HBS) 301. Only one home base station HBS 301 is illustrated in FIG. 1, but it will be understood that many hundreds of these elements may be included in the unlicensed-radio access network 30. This element handles the radio link protocols with the mobile station MS 1 and contains radio transceivers that define a cell in a similar manner to the operation of a conventional GSM base station transceiver BTS 103. All home base station HBS 301 are controlled by a home base station controller HBSC 303, which communicates with a mobile service switching centre MSC 202 over the GSM standard A interface and also with a serving GPRS support node SGSN 203 over a standard Gb interface, if available in the core network portion. The home base station controller HBSC 303 provides the connection between the MSC 202 or SGSN 203 and mobile station 1. The joint function of the home base station HBS 301 and the home base station controller HBSC 303 emulates the operation of the BSS 10 towards the SGSN 203 and MSC 202. In other words, when viewed from the elements of the core network 20 such as the mobile service switching centre (MSC) 202 and the serving GPRS support node (SGSN) 203, the access network portion 30 constituted by the home base stations HBS 301 and the home base station controller HBSC 303 looks like a conventional access network portion 10.

The applications that run on the mobile station MS 1 on top of the public mobile network radio interfaces also run on top of Bluetooth radio between the mobile station 1 and the home base station HBS 301.

The interface between the home base station HBS 301 and the home base station controller HBSC 303 which is designated Y in FIG. 1 is provided by a packet-switched broadband network, which may be a fixed network. The home base station 301 is intended to be a small device that a subscriber can purchase and install in a desired location such as the home or an office environment to obtain a fixed access to the mobile network. However, they could also be installed by operators in traffic hotspots. In order to reduce the installation costs on the part of the operator, the interface between the home base station 301 and the home base station controller 303 preferably exploits a connection provided by an already existing network 302. Suitable networks might include those based on ADSL, Ethernet, LMDS, or the like. Home connections to such networks are increasingly available to subscribers. Although not shown in FIG. 1, the home base station HBS 301 will be connected to a network terminal giving access to the network 302, while the home base station controller HBSC 303 may be connected to an edge router ER of the network 302 that also links the network 302 to other networks such as intranets and the internet. The Internet protocol, IP, is used for communication between the home base station HBS 301 and home base station controller HBSC 303 over the network 302 to render the transport of data independent of the network type. The link between the home base station HBS 301 and the home base station controller HBSC 303 is preferably always open, so that this connection is always available without the need for reserving a channel. While the network 302 is preferably an IP-based network, ATM-based networks could also be used. In particular when DSL technologies are used in this network, they could be used directly on top of the ATM layer, since they are based on ATM. Naturally, an ATM based network could also be used to transport IP, serving as a base layer.

The home base station HBS 301 is installed by plugging it in to a port of a suitable modem, such as an ADSL or CATV modem, to access the fixed network 302. The port is in contact with an intranet that is either bridged or routed on the IP level. Thus standard protocols, such as IP, DHCP, DNS and the like are used.

The home base station HBS 301 may serve as a dedicated access point to the unlicensed-radio access network. In this case the home base station HBS 301 is capable of communicating independently with the mobile station 10 over the unlicensed-radio interface X or with the access controller 303 over the broadband network interface Y. The home base station HBS 301 utilises the standard protocols and functions to ascertain to which home base station controller HBSC 303 it should connect, and also to establish a connection with this home base station controller HBSC 303.

In an alternative embodiment the home base station 301 serves as an essentially transparent access point when viewed both from the access controller 303 and the mobile station 10. In other words, this access point relays all information at the IP level and above that is transmitted from either the mobile station 10 or the access controller. It simply effects the conversion between the OSI reference model layer 1 and 2 unlicensed-radio and terrestrial access layer services. Accordingly, the mobile station 10 establishes a connection with the access controller 303 without recognising the access point as a node in the connection. Similarly the access controller 303 could establish a connection with the mobile station 1 directly.

The base stations 101 and 301 in both the conventional access network 10 portion and the unlicensed-radio access network portion 30 define a coverage area depicted in FIG. 1 by hexagonal cells 104, 304. While the relative dimensions of these cells are not accurate in the figure, it is nevertheless clear that the coverage of a conventional BTS 101 is far greater than the comparatively low power HBS 301. For this reason, and because an HBS 301 can be installed wherever there is a port to the fixed broadband network connected to an HBSC 303, one or more mini-cells 304 generated by HBS's 301 may be located inside the cell 104 of a conventional BTS 101.

In a conventional GSM network, handover of calls between adjacent cells is enabled by informing the currently connected access network 10 and the core network portion 20 of the identification of neighbouring cells by means of a cell global identifier CGI, which contains the mobile country code, mobile network code, location area code and a cell identifier, and also information about which BSC 103 and MSC 202 (or SGSN 203, if available in the network) controls these cells. The BSC 103 must be able to communicate the absolute radio frequency channel numbers (ARFCN) allocated to all neighbouring cells to a mobile station 1 connected to it so that the mobile station 1 can measure the associated frequencies and report back the strongest frequencies. In addition to the channel number ARFCN, this message also includes a base station identity code BSIC that is unique in the area to the base station transmitting on the identified channel frequency. With the introduction of a large number of mini-cells 304 resulting from the installation of an unlicensed-radio access network 30 this kind of operation and maintenance activity becomes very complex and cumbersome, particularly as the location of the mini-cells may change over time.

In accordance with the present invention, rather than allocating a unique cell identifier, base station identifier and frequency channel number to each mini-cell 304, all mini-cells 304 in the same unlicensed-radio access network are identified to the GSM network by the same identification. In effect, the whole unlicensed-radio access network 30 or rather the home base station controller HBSC 303 controlling this access network is assigned a single unique cell identification. The cell identification is in a form that can be recognised by the core network of the licensed mobile network. When this core network is GSM, the cell identification is preferably equivalent to the cell global identifier CGI used in a conventional GSM network. For the purposes of the example, the cell identifier will be referred to as HBSC-CGI. If more than one unlicensed-radio access network is present, each will have a single associated cell identifier HBSC-CGI.

In a further departure from handover in a conventional licensed radio cellular network, the single cell identifier HBSC-CGI for each unlicensed-radio access network is configured only in the nodes of the core network. There is no need to configure the identity of neighbouring unlicensed radio cells 304 in the base station subsystems BSS 10. However, these elements and the mobile stations MS 1 have an additional functionality not present in the conventional mobile network. Specifically, the mobile stations 1 capable of communicating via an unlicensed-radio access network receive the allocated cell identifier HBSC-CGI when they first establish a connection with the access network 30. This information is then sent to the base station subsystem BSS 10 handling an active call, which in turn is able to pass this identifier HBSC-CGI as the target cell for handover. The core network portion 10 recognises the cell identifier HBSC-CGI as the cell handled by the home base station controller 303 and directs the handover request to this node.

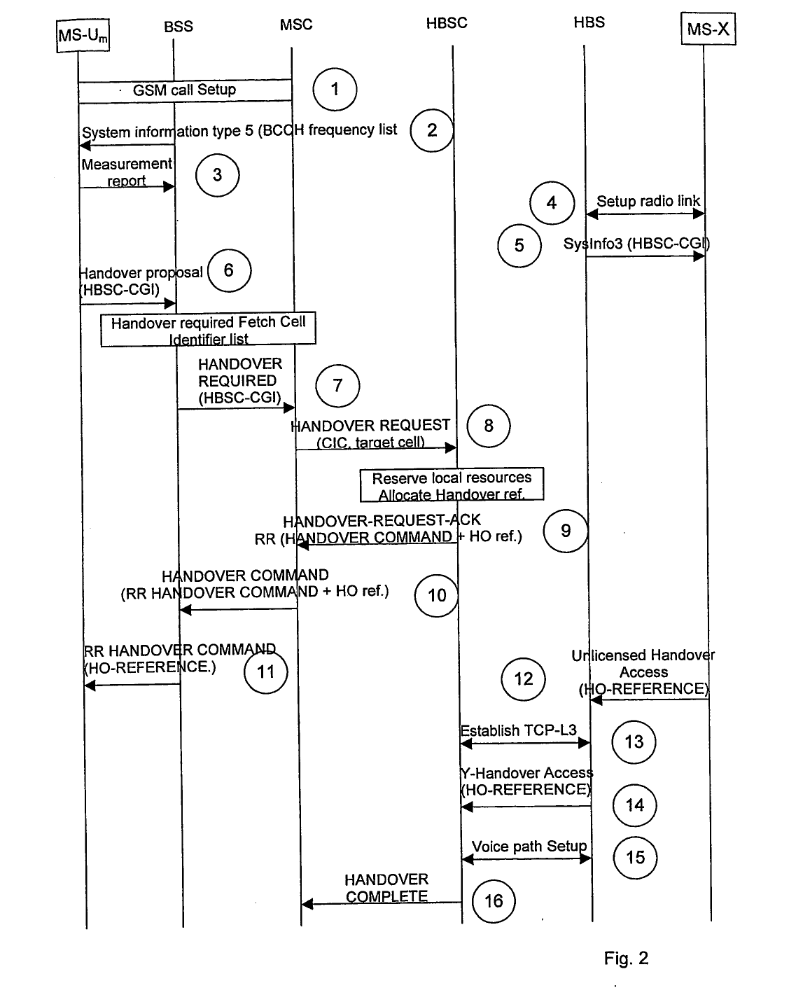

FIG. 2 illustrates the signalling sequence conducted between a mobile station MS 1, a base station subsystem BSS 10, the mobile services switching centre MSC 202, the home base station controller HBSC 303 and a dedicated home base station HBS 301 when an active call conducted between the mobile station 1 via the conventional base station subsystem BSS 10 is handed over to a home base station HBS 301 of the unlicensed-radio access network.

In FIG. 2 the various elements involved in the signalling are shown at the top of the drawing. The mobile station MS is indicated twice on either side of the figure. The left hand mobile station MS-Um represents the standard GSM Um interface and the right-hand mobile station MS-X represents the unlicensed radio interface, or X-interface, of the same mobile station. Referring now to event 1 of FIG. 2, it is assumed that a GSM call has been set up between a mobile station MS and a base station subsystem BSS via the standard Um interface. At event 2, the base station subsystem BSS transmits system information to the mobile station MS, for example in a system information Type 5 message. This includes the list of frequencies the mobile station MS should measure for handover purposes. This measurement list includes the absolute radio frequency channel number ARFCN assigned to the unlicensed-radio access network. A measurement report on the frequencies listed is sent from the mobile station MS to the base station subsystem BSS at event 3. At event 4 the mobile station has wandered into the coverage area or mini-cell of a home base station HBS of an unlicensed radio access network. The mobile station sets up a radio link with the home base station HBS via the unlicensed radio interface X. The mobile station MS is then able to receive system information from the home base station HBS including the unlicensed-radio access network identifier HBSC-CGI at event 5. This information is preferably sent in a System Information 3-type message. This identifier is then sent by the mobile station MS to the base station subsystem BSS in a handover proposal message at event 6. At event 7 the base station subsystem BSS triggers handover by sending a HANDOVER-REQUIRED message (GSM 08.08) to the mobile services switching center MCS identifying the unlicensed-radio access identifier HBSC-CGI communicated by the mobile station MS. At event 8, the mobile services switching center MSC sends the HANDOVER-REQUIRED message to the home base station controller HBSC. In addition to the cell identifier (CGI), this message now also includes a circuit identification code (CIC) that will be used in the A-interface if handover is successful. The circuit identification code CIC is configured in the core network in association with the HBSC-CGI. On receipt of this message, the home base station controller HBSC reserves the necessary local resources and assigns a handover reference number (HO reference) to this handover. It should be noted that the home base station controller HBSC does not know at this stage which home base station HBS and associated mini-cell this handover request concerns. At event 9 the home base station controller HBSC creates the required HANDOVER COMMAND message concerning the radio resource layer (RR) containing the handover reference number (HO REFERENCE). This HANDOVER COMMAND message is then included in a handover acknowledgement message (HANDOVER-REQUEST-ACK) sent to the mobile services switching center MSC. The handover required message is then acknowledged with the HANDOVER COMMAND message sent to the base station subsystem BSS at event 10 and the HANDOVER COMMAND message transmitted to the mobile station MS at event 11.

The mobile station then sets up the necessary connection toward the home base station controller HBSC via the home base station HBS. This is achieved by the transmission of an appropriate message at event 12, which is called “unlicensed handover access”. This message includes the handover reference number (HO reference). After setting up a connection across the fixed broadband network at event 13, the home base station then transmits at event 14 the handover access message, which includes the handover reference number (HO reference) and additionally all other data necessary for the connection, such as the IP related data for the connection across the broadband network 302. This may include, for example, the IP-address and UDP port of the home base station HBS to which the voice or data packets should be sent.

When the home base station controller HBSC receives this message it is able to associate it with the previous handover request using the handover reference number (HO reference). The home base station controller HBSC then uses the CIC value previously communicated to it to connect the allocated circuit via the A-interface with the IP resources. Similarly, the home base station controller HBSC sends the necessary IP information, such as the voice IP address and UDP-port, to the home base station HBS to set up a bi-directional voice path at event 15. After this the home base station controller HBSC sends a HANDOVER COMPLETE message to the mobile services switching center MSC in acknowledgement of successful handover at event 16. The mobile services switching center MSC can then release the old voice path used in the base station subsystem BSS.

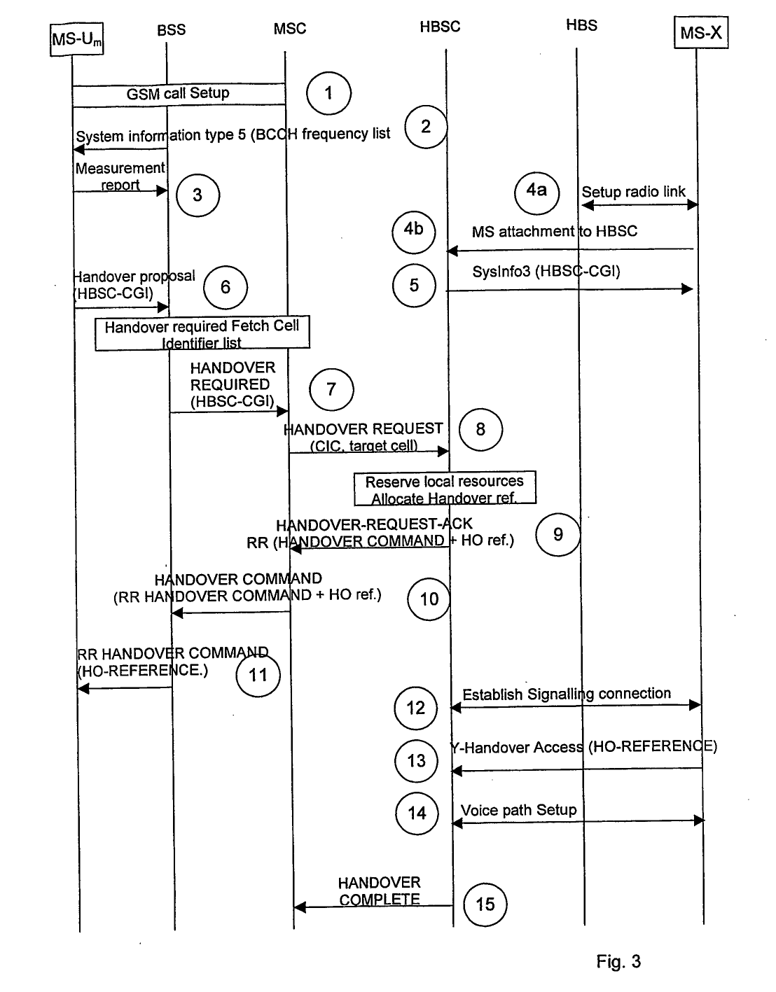

FIG. 3. illustrates the signalling for an alternative embodiment of the unlicensed-radio access network 30 in which the home base stations HBS are transparent access points with the functionality of the dedicated home base stations HBS being transferred to the home base station controller and/or the mobile station. In this embodiment, the mobile station communicates directly with the home base station controller HBSC 303 over an unlicensed-radio interface and the broadband network via the access point. Referring now to FIG. 3 all steps are the same as for the embodiment illustrated in FIG. 2 with the exception of the steps involving communication between the mobile station MS-X and the home base station HBS. Specifically, event 4 comprises a first event 4a during which the mobile station MS establishes an unlicensed radio link with the home base station HBS and a second event 4b during which the mobile station attaches to the home base station controller HBSC over the broadband IP network 302. At event 12 the mobile station MS establishes a signalling connection directly with the home base station controller HBSC via the unlicensed radio interface X and the broadband network 302. The Y-handover access (HO-REFERENCE) is transmitted to the home base station controller HBSC by the mobile station at event 13 and at event 14 the voice path between the mobile station MS and the home base station controller HBSC is set up. The HANDOVER COMPLETE-message is then sent as in the first embodiment at event 15.

In the signalling for both embodiments the “handover proposal” message sent at event 6 by the mobile station MS to the base station subsystem BSS could be a new type of message or alternatively be a modification of and existing message type, for example the measurement report message sent at event 3. In either case, the base station subsystem BSS must be able to receive and respond to this special message. The HANDOVER-REQUIRED-message sent at event 7 is a standard GSM message so that there is no modification required for communication between the base station subsystem BSS and the core network portion.

In order to ensure that the base station subsystem BSS is capable of receiving the special “handover proposal” message or modified measurement report in place of the standard measurement report message, the base station subsystems BSS that support this function preferably indicate this capability in the System Information Type 5 message sent to mobile stations, e.g. at event 2 in FIGS. 2 and 3.

A further modification of the base station subsystems BSS that reduces the expenditure of unnecessary core network resources is for each base station subsystem capable of supporting this function to hold a blacklist of target cells proposed by a mobile station MS but to which handover has been unsuccessful. This list is held in a memory in the base station controller (103) and is accessible by a processor in the base station controller on receipt of a “handover proposal” message. If handover to a target cell fails a significant number of times, the target cell identifier HBSC-CGI will be added to the list. Any renewed attempt by a mobile station MS to request handover to such a cell would then be denied.

The above detailed description of handover has referred only to GSM networks as a conventional public mobile network. It will be understood by those skilled in the art, however, that handover from other conventional public mobile networks, such as UMTS or CDMA2000, to an unlicensed-radio access network can be handled in an analogous manner. In all cases, the cell identifier should be selected to have a form that is recognised by the core network elements so that no modification of these elements is necessary.

1. A mobile telecommunications network including a core network portion (20), at least one first access network (10), and at least one second access network portion (30), wherein said first access network portion comprises a plurality of base stations (10) adapted to communicate with mobile stations (1) over a licensed radio interface and with said core network portion (20) and said second access network comprising a plurality of access points (301) each defining a mini-cell and adapted to communicate with mobile stations (1) located in a respective mini-cell over an unlicensed-radio interface (31);
an access network controller (303) adapted to communicate with said core 15 network portion over a predetermined licensed mobile network interface and connected with said plurality of access points (301),
said second access network (30) is adapted to set up a radio link with a mobile station when said mobile station entering a mini-cell is conducting an active call with said first access network and to communicate a cell identifier to said mobile station, said identifier identifying at least one mini-cell of said second access network (30) to said core network portion (20) to enable handover of an active call from said first access network (10) to said second access network, and that at least one base station (10) of said first access network is adapted to receive a message from said mobile station containing said cell identifier and to communicate said cell identifier to said core network portion in a message indicating that handover is required, characterized in that
said access network controller (303) is adapted to receive a handover request from said core network portion (20) containing said cell identifier, to assign a handover reference to said request and to set up a communication path between a mobile station and said core network portion when a message containing said handover reference is received from said mobile station (1).

2. A network as claimed in claim 1, characterised in that said second access network (30) is adapted to communicate the same cell identifier to mobile stations entering all mini-cells in said second access network.

3. A network as claimed in claim 1, characterised in that an access point (301) is adapted to communicate said cell identifier to said mobile station.

4. A network as claimed in claim 1, characterised in that a access network controller (303) is adapted to communicate said cell identifier to said mobile station.

5. A network as claimed in claim 1, characterised in that said core network portion (20) views said cell identifier as a single cell address.

6. A network as claimed in claim 1, characterised in that a broadband packet-switched network (302) is provided for connecting said plurality of access points (301) with said access network controller (303).

7. A network as claimed in claim 1, characterised in that said at least one base station (10) of said first access network is adapted to inform a mobile station of its ability to trigger handover upon receipt of a message from said mobile station containing said cell identifier.

8. A network as claimed in claim 1, characterised in that said at least one base station (10) of said first access network includes a memory for storing a list of cell identifiers that identify mini-cells towards which handover has failed a predetermined number of times, said base station (10) further being adapted to consult said memory on receipt of a message containing a cell identifier and to deny handover if said cell identifier is contained in said memory.

9. A mobile station adapted to communicate with an access network (10) of a licensed-radio mobile communications network (20) via a licensed radio interface and with an unlicensed-radio access network (30) connected to said licensed-radio mobile communications network via an unlicensed-radio interface, said mobile station (1), while conducting an active call with said licensed radio access network, being adapted to receive from said unlicensed-radio access network via said unlicensed-radio interface a cell identifier, said identifier identifying at least one mini-cell of said unlicensed-radio access network (30) to said core network portion (20) for enabling handover of an active call from said licensed radio access network (10) to said unlicensed radio access network, and being adapted to communicate said cell identifier to said licensed-radio access network in a handover proposal message, characterised in that said mobile station is further adapted to receive a handover command message from said licensed-radio access network in response to said handover proposal message, said handover command reference including a handover reference, and to communicate said handover reference to said unlicensed-radio access network to obtain handover.

10. A method of handing over an active call conducted with a mobile station from a cell of a public licensed mobile network to a mini-cell of an unlicensed-radio access network connected to said public mobile network, 30 said public licensed mobile network comprising an access portion (10) defining said cell and a core network portion (20) connected to said access portion, said unlicensed-radio access network (30) comprising a plurality of access points (301) each defining a mini-cell and adapted to communicate with a mobile station (1) via an unlicensed-radio interface and an access network controller (303) adapted to communicate with said access points and with the core network portion of said public mobile network, said method including:
said unlicensed-radio access network establishing a radio link with a mobile station conducting an active call with said licensed radio access network but located within said mini-cell,
said unlicensed-radio access network communicating a cell identifier to said mobile station, said cell identifier identifying at least said mini-cell as a target cell for handover to said core network portion,
said licensed radio access network receiving a handover proposal message from said mobile station containing said cell identifier, and transmitting said cell identifier to said core network portion in a handover request message, characterised by the further steps of:
said core network portion associating said cell identifier with said access network controller and sending a handover request message to said access network controller,
said access network controller responding to a handover request message received from the core network portion by generating a handover reference and transmitting said handover reference as a handover acknowledgment message to said core network portion (10),
said access network controller (303) receiving said handover reference from said mobile station via said local base station (301) and setting up a communication path with said mobile station in response to said received handover reference.

11. A method as claimed in claim 10 further characterised by the steps of:
assigning a single common cell identifier to all mini-cells of said unlicensed-radio access network.

12. A method as claimed in claim 10, further characterised by the steps of:
said licensed radio access network storing cell identifiers identifying mini-cells towards which handover has failed a predetermined number of times, and
consulting said stored cell identifiers upon receipt of a handover proposal message from a mobile station and denying handover if said message contains a stored cell identifier.

13. A method as claimed in claim 10, further characterised by the steps of:
said licensed radio access network indicating to said mobile station its ability to trigger handover on receipt of a handover proposal message from said mobile station containing said cell identifier.
